(19) United States
(12) Patent Application Publication
(10) Pub. No.: US 2005/0031829 A1
(43) Pub. Date: Feb. 10, 2005

(54) Rubber and textile mat

(76) Inventors: R Bruce Crenshaw, Hungtington, CA (US); Raul S. Perez, Pasadena, CA (US)

Correspondence Address: FOLEY & LARDNER, 777 EAST WISCONSIN AVENUE, SUITE 3800, MILWAUKEE, WI, 53202-5308, US

(21) Appl. No.: 10/486,568

(22) PCT Filed: Aug. 12, 2002
(86) PCT No.: PCT/US02/25182

Related U.S. Application Data
(60) Provisional application No. 60/311,544, filed on Aug. 10, 2001.
(60) Provisional application No. 60/311,639, filed on Aug. 10, 2001.

(51) Int. Cl. B32B 27/20; D06N 7/00

(52) U.S. Cl. 428/95; 428/87

(57) ABSTRACT

A mat for use in commercial, residential, and/or automotive applications includes a rubber layer comprising rubber particles and a matrix material proximate the rubber particles. The matrix material comprises a barrier material and a binder material. The mat also includes a textile layer thermally bonded to the rubber layer. The textile layer comprises a backing layer comprising polyester. The textile layer further comprises a tufted textile surface coupled to the backing layer.

### CROSS-REFERENCE TO RELATED PATENT APPLICATIONS

This application claims priority to U.S. Provisional Patent Application No. 60/311,639 filed Aug. 10, 2001 and entitled “Rubber Mat” (Atty. Dkt. No. 048680-0149) and U.S. Provisional Patent Application No. 60/311,544 filed Aug. 10, 2001 and entitled “Rubber and Textile Mat” (Atty. Dkt. No. 048680-0150), both of which are incorporated by reference in their entirety herein.

### FIELD OF THE INVENTION

The present invention relates generally to the field of rubber mats. More specifically, the present invention relates to floor mats for use in commercial, residential, and automotive applications.

### BACKGROUND OF THE INVENTION

Mats (e.g., floor mats) of various configurations and designs may be used in commercial, residential, and automotive applications. For example, a floor mat may be placed at an entryway to a building to allow individuals to remove moisture (e.g., water) and debris (e.g., dirt) from their shoes prior to entering the building. In the automotive context, floor mats are typically provided to prevent moisture and debris from damaging fabric included on the floor of a vehicle passenger compartment.

One material that has been used to form mats is rubber. For various reasons (e.g., reduced cost, resource and environmental conservation, etc.), it is desirable to use a recycled (e.g., post-consumer) rubber material in the formation of mats. Various difficulties are presented with the use of recycled rubber, however. For example, breakdown products (e.g., grease, oils, etc.) present in recycled rubber may migrate or escape from the mat, which may stain or discolor a surface on which the mat is placed (e.g., a floor). For this reason, mats incorporating recycled rubber have generally been used in outdoor applications.

Another issue with the use of recycled rubber is that mats produced with such materials generally have a black color, since a large amount of recycled rubber is typically obtained from recycled automobile tires. A mat having a black color may not have the aesthetic appeal that a mat having a different color may provide. For example, while a black rubber mat may be suitable for commercial applications (e.g., store entryways, etc.), residential and automotive customers may prefer a rubber mat having a color that matches or is compatible with other colors present where the mat will be placed (e.g., a wall color, etc.).

In certain applications, it may be desirable to produce a mat that includes a rubber layer and a textile layer. The textile layer may allow an individual to more easily remove moisture and debris from shoes and/or may provide additional aesthetic appeal to the mat. One method that may be used to secure a textile material to a rubber layer is to introduce a liquid latex material between the textile material and the rubber layer. This method has the disadvantage of requiring an additional material and processing step in the manufacture of rubber and textile mats.

Thus, there is a need for a mat for use in indoor and outdoor applications that is formed using recycled rubber. There is also a need to provide a recycled rubber mat that does not stain or discolor a surface (e.g., a floor) on which it is placed. There is also a need for a rubber mat that includes a colorant to allow production of rubber mats in a variety of colors. There is further a need for a mat that includes a textile surface that may be thermally bonded directly to a rubber layer. There is further a need for a method of producing a mat having a rubber backing layer and a textile surface that reduces the number of processing steps and the amount of material required.

### SUMMARY OF THE INVENTION

An exemplary embodiment relates to a mat. The mat includes a rubber layer comprising rubber particles and a matrix material proximate the rubber particles. The matrix material comprises a barrier material and a binder material. The mat also includes a textile layer thermally bonded to the rubber layer. The textile layer comprises a backing layer comprising polyester. The textile layer further comprises a tufted textile surface coupled to the backing layer.

Other exemplary embodiments relate to other features and combinations of features as may be generally recited in the claims.

### BRIEF DESCRIPTION OF THE DRAWINGS

FIG. 1 is a perspective view of a mat according to an exemplary embodiment.

FIG. 2 is a schematic cross-sectional view of a rubber layer included in the mat shown in FIG. 1.

FIG. 3 is a schematic cross-sectional view of the mat shown in FIG. 1 illustrating a textile layer bonded to a rubber layer.

FIG. 4 is a schematic cross-sectional view of the textile surface shown in FIG. 3.

FIG. 5 is a flow chart illustrating a method of producing the mat shown in FIG. 1 according to an exemplary embodiment.

### DETAILED DESCRIPTION OF THE PREFERRED EMBODIMENTS

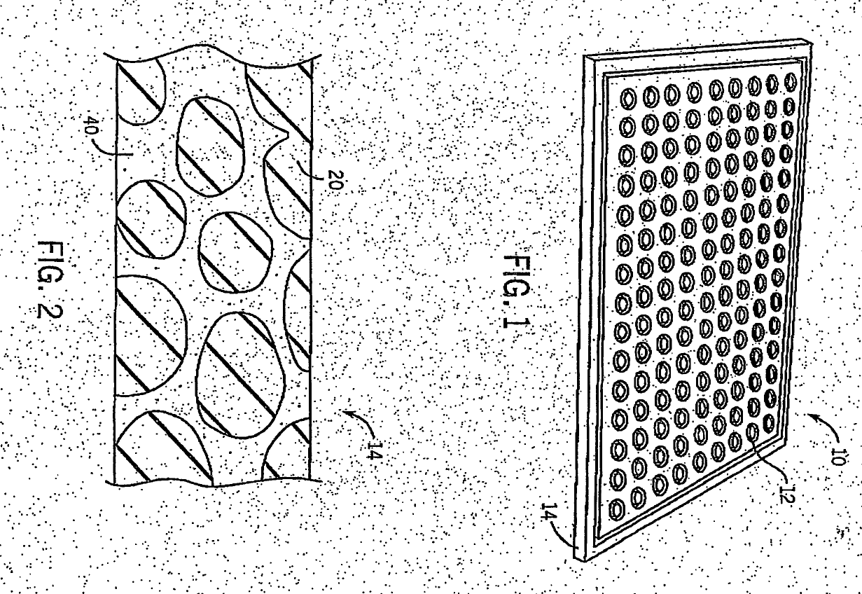

Referring to FIG. 1, a perspective view of a mat 10 according to an exemplary embodiment is shown. Mat 10 includes a textile layer 12 coupled or attached to a rubber layer 14. Rubber layer 14 may provide a relatively heavy, skid-resistant backing layer or base for mat 10 that is relatively easy to clean and resists soiling (e.g., mildew formation, etc.). According to an alternative embodiment, a textile layer may be provided on both sides of a rubber layer. According to another alternative embodiment, a mat may include only a rubber layer without an attached textile layer.

FIG. 2 is a cross-sectional view of rubber layer 14 according to an exemplary embodiment. Rubber layer 14 includes rubber particles 20 and a matrix material 40. Rubber particles 20 may be made of any type of rubber material suitable for use in mat applications (e.g., floor mats, automotive mats, etc.). According to a preferred embodiment, the rubber is recycled or post-consumer rubber. Such recycled rubber may come from any of a variety of sources (e.g., scrap from the production of automotive tires, discarded tires used in service on vehicles, or from other products or sources from which rubber may be recycled), and may include vulcanizing agents such as sulfur.

According to other exemplary embodiments, the rubber may include non-recycled rubber (e.g., rubber that has not previously been used in other applications) or mixtures of recycled and non-recycled rubber. The rubber used for rubber layer 14 may be synthetic or natural rubber. Any combination of recycled, non-recycled, synthetic, and natural rubber may be used in alternative embodiments.

Rubber particles 20 may be a granular or crumb rubber (e.g., crushed, ground, shredded, etc.). According to an exemplary embodiment, the rubber has a particle size of less than or equal to 10 mesh. According to other alternative embodiments, different rubber particle sizes and shapes may be used (e.g., 5 mesh, 20 mesh, etc.) depending on the desired application, processing considerations, and other design constraints. According to an alternative embodiment, both particle and non-particle rubber are used. For example, particles of rubber may be used in conjunction with a liquid rubber such as latex.

Matrix material 40 coats or encapsulates individual or groups of rubber particles 20, and includes a binder (e.g., an adhesive) and a colorant. Matrix material 40 may be at least partially responsible for providing strength and durability to mat 10 and may also reduce the occurrence of ripping or tearing of the mat.

According to a preferred embodiment, the binder is an isocyanate binder, such as MDI produced by Ryvek Incorporated of Anaheim, Calif. According to alternative embodiments, other types of binders, including other types of isocyanate binders, may be utilized. According to another alternative embodiment, a surface-activated crumb rubber may be used for the rubber particles. Such crumb rubber may include a binder or other activated surface configured to adhere the rubber particles together and/or to a polyester or other material.

According to an exemplary embodiment, the binder is provided in fluid form. According to an alternative embodiment, the binder is a granular or powdered material to which fluid may be added to form a liquid binder. It is intended that providing a binder in liquid form allows the binder to flow between the rubber particles to ensure that substantially all rubber particles are adequately bonded together.

According to an exemplary embodiment, rubber layer 14 may include up to approximately 15 percent binder by weight. The exact amount of binder may vary depending on the desired strength and performance characteristics of the mat, cost considerations, and other design constraints. According to an exemplary embodiment, a rubber layer may include approximately 8 percent binder by weight. According to other exemplary embodiments, the rubber mat may include between 6 and 10 percent binder by weight.

According to an exemplary embodiment, binder 40 is activated (e.g., changes from a non-bonding substance to a bonding substance) at a temperature between approximately 212° F. and 500° F. According to another exemplary embodiment, the binder is activated at a temperature of between approximately 270° F. and 330° F.

The binder provided in rubber layer 14 by itself may exhibit limited resistance (e.g., may be permeable, etc.) to breakdown products associated with rubber particles 20. As described above, matrix material 40 includes both a binder and a colorant. The colorant may be added to the binder to form a matrix material that has enhanced resistance to staining or discoloration of surfaces as a result of grease and oil migration from the rubber particles and/or the rubber layer.

According to an exemplary embodiment, the colorant includes a barrier material (e.g., particles of titanium dioxide, etc.), a coloring pigment, and a dispersing agent such as an oil. According to an alternative embodiment, no coloring pigment is included in the colorant. It is intended that the barrier material acts to prevent migration of breakdown products. When the colorant and binder are mixed together, a substantially homogeneous mixture is formed. The barrier material is thus dispersed throughout matrix material 40 and acts to contain breakdown products within rubber layer 14. It is also intended that the barrier material at least partially contributes to improved wearability of the mat.

The colorant is present in rubber layer 14 in an amount up to approximately 15 percent by weight, depending on desired performance characteristics, cost considerations, and other design constraints. According to an exemplary embodiment, rubber layer 14 includes approximately 8 percent colorant by weight. According to other exemplary embodiments, the colorant may form between approximately 6 and 10 percent of the weight of the rubber layer.

The amount of colorant provided in the rubber layer may vary depending on the thickness of the rubber layer and the age and/or type of rubber used. For example, newer recycled rubber (e.g., scrap rubber that has not had a service life on an automobile) may include a larger amount of grease and/or oil. Where newer recycled rubber is used, a greater amount of colorant may be required to ensure that an adequate amount of barrier material is provided to prevent breakdown products from escaping. In contrast, where an older recycled rubber is used, less remaining breakdown products may be present in the rubber particles (e.g., it has escaped from the rubber during its original use). In such a situation, less barrier material (and hence less colorant) may be required to prevent staining or discoloration of a surface upon which the rubber mat is positioned.

According to an exemplary embodiment, colorant 30 includes a barrier material of titanium dioxide (TiO₂) in an amount between approximately 50 and 75 percent of the barrier material by weight. According to alternative embodiments, other barrier materials may be used (e.g., silica, carbonate, or other materials that may be incorporated within a matrix material to reduce or prevent migration of breakdown products from rubber particles).

According to an exemplary embodiment, the colorant also includes a coloring pigment or additive that may be any of a variety of color concentrates. Preferably, the coloring pigment is compatible with an isocyanate binder, such that when the colorant and binder are mixed together, a substantially homogeneous mixture is formed. The remainder of the colorant (i.e., the portion that is not barrier material or pigment) may include a dispersing agent such as an oil that is compatible with the binder used in rubber layer 14. The colorant may exhibit a color-fast property that prevents the coloring pigments from escaping the rubber mat, such that the floor or other surface on which the rubber mat is placed will not be stained or discolored by the coloring pigments.

The amount of coloring pigment provided in the colorant may be small or trace when compared to the amount of barrier material. According to an exemplary embodiment, the coloring pigment is less than approximately 15 percent of the colorant by weight. According to another exemplary embodiment, the coloring pigment is less than 2 percent of the colorant by weight. According to another exemplary embodiment, between approximately 2 and 15 percent pigment is used. According to an alternative embodiment, no coloring pigment is used (e.g., the colorant exhibits a substantially bluish-white or white appearance). Regardless of whether a coloring pigment is provided, colorant may alter the color of rubber layer 14, since titanium dioxide or other materials included in the colorant may give matrix material 40 a color. The binder may also contribute to coloring of the rubber layer. According to another alternative embodiment, a coloring pigment may be added separately to the colorant or to the colorant/binder mixture.

One advantageous feature of providing a coloring pigment in the colorant is that rubber mats may be produced with an enhanced visual or aesthetic appeal. For example, mats that include recycled rubber may exhibit a black color. By providing a colorant in rubber layer 14, a rubber layer having any of a variety of different colors may be produced. According to an exemplary embodiment, the coloring pigment provides for production of a rubber layer having a substantially taupe color. According to other embodiments, other pigment colors may be used.

According to an exemplary embodiment, the amounts of colorant and binder used in rubber layer 14 are substantially equal (e.g., where approximately 8 weight percent binder is used, between approximately 6 and 10 weight percent colorant is used). The following table illustrates several nonexclusive alternative embodiments:

| Binder | Colorant |
|---|---|
| (weight percent) | (weight percent) |
| 1-3 | 1-3 |
| 3-6 | 1-6 |
| 6-9 | 1-9 |
| 9-12 | 1-12 |
| 12-15 | 1-15 |
| 1-15 | 1-15 |
| 1-3 | 2-6 |
| 4-6 | 7-9 |
| 7-9 | 10-12 |
| 10-12 | 13-15 |

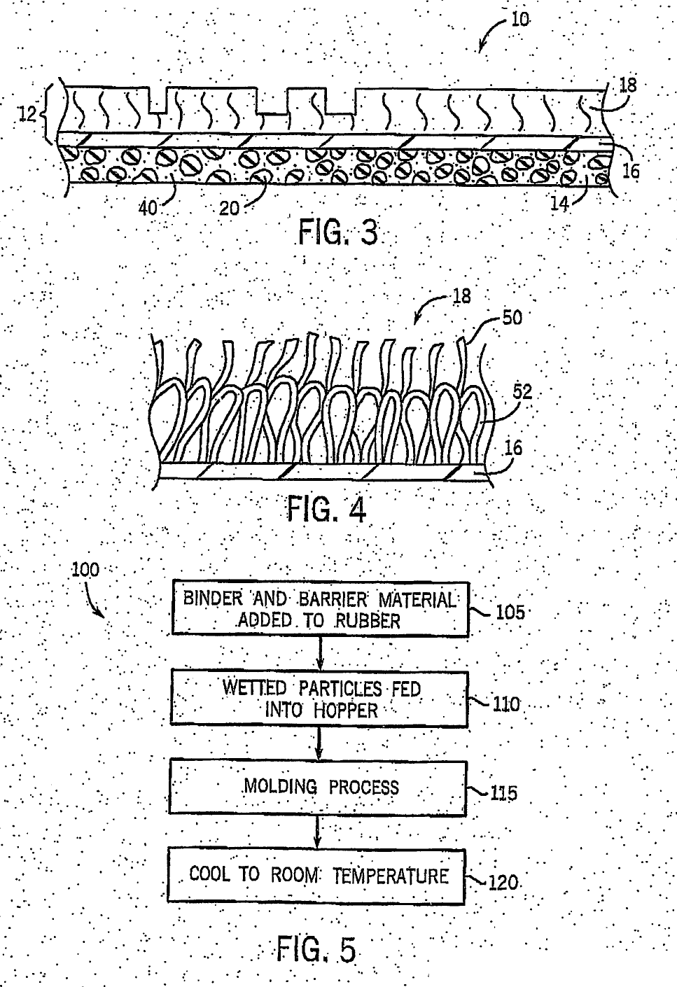

FIG. 3 is a cross-sectional view of mat 10 including textile layer 12 and rubber layer 14. Textile layer 12 and rubber layer 14 may be configured to provide deep channels to hold and conceal debris and moisture. Any of a variety of textile patterns may be used for textile layer 12, and textile layer 12 may cover the entire surface of rubber layer 12 or a portion thereof.

Textile layer 12 includes a backing layer 16 and a textile surface 18. Backing layer 16 is provided intermediate or between textile surface 18 and rubber layer 14 for facilitating attachment of textile surface 18 to rubber layer 14. Coupling of textile layer 12 to rubber layer 14 may be achieved regardless of whether a colorant is provided in rubber layer 14.

Backing layer 16 is a polyester or polyester blend material, and may be woven or non-woven. Polyester material included in backing layer 16 exhibits an affinity for bonding to the binder provided in rubber layer 14. For example, according to an exemplary embodiment, the backing layer bonds with an isocyanate binder used in rubber layer 14. According to an alternative embodiment, a textile surface may include a polyester or polyester blend material and may be attached directly to a binder provided in a rubber layer without the use of an intermediate backing layer. For example, the textile surface may be a non-woven polyester including material.

According to an exemplary embodiment, backing layer 16 is made entirely of polyester. According to an alternative embodiment, a backing layer includes between 50 and 75 percent polyester. In other alternative embodiments, backing layers may include any proportion of polyester sufficient to bond the backing layer to a binder included in a rubber layer. For example, backing layers having very small proportions of polyester (e.g., 3-5 percent) may be used. Any amount of polyester may be used in the backing layer, up to a maximum percentage of 100 percent.

It is believed that the strength of the bond between the binder and the backing layer (or, alternatively, between the binder and the textile surface) increases with increasing polyester composition. It may therefore be desirable to increase the amount of binder in a rubber material with decreasing polyester content in a backing layer or textile surface. The particular relationship between polyester and binder may be the subject of experimentation, and any suitable combination of the two components may be used to provide a bond between the backing layer and rubber layer.

According to an alternative embodiment, a backing layer may include a non-polyester or non-polyester blend material. According to this embodiment, the backing layer may be attached to a rubber backing layer by mechanical means. For example, a wire brush may be used to brush the surface of the backing layer to give the surface of the backing layer a fuzzy appearance (i.e., strands or fibers of the material extend from the surface thereof). The strands of fibers may then be introduced into the binder to adhere the backing layer to the rubber layer. Binder present in the rubber layer may retain the backing layer in place by surrounding the strands of fibers extending from the backing layer and subsequently hardening around the fibers. Attachment of a textile surface material directly to a rubber material may also be accomplished in a similar manner.

Backing layer 16 may be attached or coupled to textile surface 18 in any conventional manner. According to an exemplary embodiment, textile layer 12 is provided as a tufted material (e.g., as shown in FIG. 4, tufted material 52, such as an olefin material, are shown as projections of yarns drawn through backing layer 16 to produce a surface of raised loops or cut pile). According to alternative embodiments, textile surfaces may be affixed to backing layers using an adhesive, a needle-punch method, or any other acceptable method. According to another exemplary embodiment, the textile surface is a non-woven material directly bonded to the rubber layer.

FIG. 4 is a cross-sectional view of a portion of textile surface 18 according to an exemplary embodiment. Textile surface 18 includes olefin fibers or strands 52 and monofilament fibers or strands 50. Olefin materials used to form olefin fibers 52 may include nylon, cotton, polyester, polypropylene, polyethylene, and blends thereof. Where a material blend is provided, the various blend components may be provided in varying proportions depending on various design configurations such as durability, texture, function, and the like. According to an alternative embodiment, other textile, cloth, or fabric materials that are acceptable for use in mats may be used in place of or in addition to the olefin fibers.

Olefin fibers are intended to provide absorption for excess moisture such as water. Liquid introduced onto mat 10 is channeled downward from the surface of the mat (e.g., by wicking or pulling water down into the mat), where the olefin fibers absorb and hold the liquid. The weave or arrangement of olefin fibers 52 allow air circulation for enhanced (e.g., quick) drying of mat 10. The use of olefin fibers advantageously allows production of a relatively abrasion and stain-resistant textile surface that is relatively simple to clean. It is intended that the use of olefin fibers provides resistance to deterioration from chemicals, mildew, and rot. It is also intended that the olefin material provides a color-fast appearance that resists fading during use.

Monofilament fibers 50 may be made from nylon, polypropylene, polyester, or other materials. According to an exemplary embodiment, monofilament fibers 50 are made of nylon. Monofilament fibers 50 are intended to provide a rough or scraping surface to allow removal of dirt and debris from shoes and other items which are rubbed or scraped across textile surface 18. As shown in FIG. 4, monofilament fibers 50 stand on end and provide an active scraping surface for cleaning cracks and crevices of shoes and other items.

One advantageous feature of using monofilament fibers 50 is that fibers 50 retain their shape after use and are relatively resilient to prolonged wear. It is intended that the monofilament fibers provide resistance to damage from chemicals and mildew. It is also intended that the use of monofilament fibers in conjunction with an olefin fiber material and a rubber layer allows for simple cleaning of the mat (e.g., by hosing the mat with water). According to an alternative embodiment, a latex rubber material is provided in the textile layer to secure the monofilament fibers in place. According to other alternative embodiments, other materials or methods may be provided to secure the monofilament fibers in place. According to yet another alternative embodiment, no monofilament fibers are included in the textile surface.

Textile layer 12 may have a “carpet-like” look and feel, or may have a short-fiber configuration. According to an alternative embodiment, the textile layer may also include a combination of carpet-like and short-fiber configurations. Textile layer 12 may have a quick-drying capability, and may include materials that are simple to keep clean.

Textile layer 12 may include a number of advantageous features. First, the textile layer may provide an aesthetic, visual, or tactile appeal. Second, the textile layer may serve to absorb fluid or retain dirt. The textile layer may be provided with one or more deep channels configured for water retention. Third, the textile layer may include a relatively hard or abrasion resistant material, such as plastic grass, to provide a scraping surface for shoes or the like. These and other advantageous features may be provided by one or more of the exemplary and alternative embodiments described above.

FIG. 5 is a flow diagram showing a method 100 of making or producing mat 10 according to an exemplary embodiment. In a step 105, a binder and colorant are added to rubber particles 20 in a continuous mixing process (e.g., using a paddle mixer) to wet the rubber particles. According to an exemplary embodiment, the binder and colorant are mixed to form a substantially homogeneous mixture, after which the rubber particles are added to the mixture. According to an alternative embodiment, the binder and colorant are mixed and added to the rubber particles. According to another alternative embodiment, the binder and colorant are added separately to the rubber particles. According to yet another alternative embodiment, no colorant is provided.

In a step 110, the wetted rubber particles are fed into a hopper, which provides the wetted rubber particles to a flat sheet or conveyor. The wetted rubber particles are leveled such that a flat sheet having a substantially uniform thickness is formed. For example, a bar leveling process may be used to level the wetted particles, in which a pile of wetted particles is placed on a flat surface and a bar is passed across the surface of the wetted particles to remove excess material and create a substantially flat sheet of wetted particles. According to an alternative embodiment, the wetted particles may be arranged such that a substantially non-uniform sheet is obtained. In this manner, a mat having a generally non-uniform thickness may be obtained. Such result may also be obtained by forming a mat using varying pressures across the surface of the mat.

In a step 115, a molding or pressing process is used to form mat 10. Textile layer 12 is placed over the wetted rubber particles. Backing layer 16 is thus positioned in direct contact with the wetted rubber particles. According to an alternative embodiment, wetted rubber particles may be provided intermediate two separate textile layers (e.g., to form a mat having two outer textile surfaces) by placing the wetted rubber particles on over an inverted textile layer (e.g., backing layer facing up) and then placing a second textile layer over the wetted rubber particles. According another exemplary embodiment, a textile material (e.g., a textile surface) may be positioned adjacent to wetted rubber particles without an intermediate backing layer to directly adhere the textile material to a rubber backing layer.

The mat components (e.g., wetted rubber particles, backing layer, and textile layer) are pressed or molded under elevated temperatures and pressures using any of a variety of molding machines and mold types. The elevated temperature activates the binder to adhere or glue adjacent coated rubber particles to each other and to adhere rubber layer 14 to backing layer 16. In this manner, mat 10 may be produced in a relatively efficient manner that does not require the use of a latex or liquid rubber layer between textile layer 12 and rubber layer 14.

The mat components are molded at a temperature of between approximately 212° F. and 500° F. to glue or fuse the rubber particles together to form a relatively strong and durable rubber layer and to adhere the textile layer to the rubber layer. According to an exemplary embodiment, a temperature of between approximately 270° F. and 330° F. (preferably approximately 300° F.) is used. The temperature chosen provides activation for the binder without overheating so as to break down the binder. The temperature or temperature range may be chosen based on the amount and type of binder used in the mat, the molding pressure, the relative humidity in the manufacturing facility, product performance, cost, manufacturability, and other factors. The temperature may also be chosen based on the type of textile material used. For instance, a higher temperature may be used when the textile material is nylon or polyester, whereas a lower temperature may be used when the textile material is polypropylene or polyethylene. Additionally, a different temperature may be used in different parts of the mold. For example, a temperature of approximately 400° F. may be used for a platen adjacent to the rubber layer, while a temperature of approximately 300° F. may be used for a platen adjacent to the textile material.

The mat components are molded at a pressure between approximately 5 and 500 pounds per square inch (psi). According to an exemplary embodiment, a molding pressure of between approximately 120 and 180 psi may be used, with a preferred pressure of approximately 150 psi. Other pressures may also be used, and the pressure may be varied based on the temperature in the mold and various other factors (e.g., design considerations such as product performance, cost, manufacturability, etc.).

The temperatures and pressures used in the molding process may vary depending on the initial and/or desired thickness of the mat, the relative percentages of components (i.e., rubber/binder/colorant) used in the rubber layer, or any other relevant criteria, such as the amount and type of textile or backing layer material used.

During the molding process, the mold may remain closed (i.e., at elevated temperature and pressure) for a time of up to approximately 20 minutes, during which the mat components are subjected to a predetermined temperature and pressure. According to an exemplary embodiment, the mold may be closed approximately 90 seconds to produce a ⅜ inch mat. The time may vary based on a variety of considerations, including the types and ratios of mat components used, the amount of material used to form the mat (hence, the thickness of the mat), and other manufacturing considerations. For example, depending on the temperature and pressure used in the mold, the amount of time the material is pressed may be varied. The maximum time in a press may be altered depending on various considerations. For example, increasing temperature along with pressure may allow for decreased pressing times. As will be recognized by those of skill in the art, any combination of time, pressure, and temperature acceptable for producing a mat having the components described above may be used.

In a step 120, mat 10 is cooled to room or ambient temperature to allow the mat to reach its final state. Upon release from the mold, mat 10 is in a “green” state, in which mechanical properties (e.g., strength, flexibility, etc.) of the mat differ from the final cooled state of the mat.

According to an exemplary embodiment, mat 10 is allowed to cool for approximately 24 hours to reach its final state. According to alternative embodiments, the amount of time the mat is given to cool may vary. The amount of time chosen may depend on the temperature and humidity in the manufacturing facility, the molding temperature, the type of binder or rubber used, or other considerations.

According to an alternative embodiment in which no textile layer is provided (e.g., a mat that includes only a rubber layer as shown in cross-section in FIG. 2), wetted rubber particles may be molded into a variety of shapes and designs to form rubber mats of various configurations. A similar process as described above with regard to the various exemplary and alternative embodiments may be used to form a rubber mat having a composition that includes rubber particles, a binder, and a colorant. Where a rubber mat having no associated textile layer is produced, a molding temperature of between 370° F. and 430° F., and preferably approximately 400° F., is used. According to alternative embodiments, a molding temperature of between approximately 212° F. and 500° F. may be used, and may be chosen to ensure proper bonding of the various components without causing a breakdown of the binder. Similar pressures and other processing conditions to those described above may be used to form a rubber mat.

Any of a variety of mat designs and configurations may be used. For example, the size of the mat may be determined based on a particular application in which the mat will be used. For example, according to an exemplary embodiment, a mat has a depth of approximately 0.5 inches, with a length of 36 inches and a width of 22 inches. According to other nonexclusive exemplary embodiments, mats having length and width dimensions of 36 inches by 60 inches, 24 by 36 inches, 18 by 30 inches, and 18 by 27 inches may be produced. Other dimensions may also be used.

Textile layer 12 may be provided in a variety of designs and configurations, and may include a variety of pictures, patterns, or designs for providing aesthetic or visual appeal. According to an exemplary embodiment, textile layer 12 covers the entire surface of rubber layer 14, such that no rubber is visible on the top surface of mat 10. According to an alternative embodiment, a textile layer is selectively attached to a rubber backing layer, such that only a portion of the rubber layer is covered by a textile material (e.g., to provide a pattern of textile material on a rubber mat).

The construction and arrangement of the elements of the rubber mat as shown in the preferred and other exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited herein. It should be noted that the elements and/or assemblies of the system may be constructed from any of a wide variety of materials that provide sufficient strength or durability, including any of a wide variety of rubber materials. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating conditions and arrangement of the preferred and other exemplary embodiments without departing from the spirit and scope of the present invention.

1. A mat comprising:
a rubber layer comprising rubber particles and a matrix material proximate the rubber particles, wherein the matrix material comprises a barrier material and a binder material; and
a textile layer thermally bonded to the rubber layer;
wherein the textile layer comprises a backing layer comprising polyester; and
wherein the textile layer further comprises a tufted textile surface coupled to the backing layer.

2. The mat of claim 1, wherein the rubber particles comprise recycled rubber and the barrier material comprises titanium dioxide.

3. The mat of claim 1, wherein the binder material comprises an isocyanate binder.

4. The mat of claim 1, wherein the binder material is adapted to bond with a polyester material at elevated temperatures.

5. The mat of claim 1, wherein the backing layer is thermally bonded to the rubber layer.

6. The mat of claim 1, wherein the textile surface comprises an olefin material.

7. The mat of claim 6, wherein the olefin material comprises at least one of nylon, cotton, polyester, polypropylene, and polyethylene.

8. The mat of claim 6, wherein the textile surface is a blended material.

9. The mat of claim 6, wherein the textile surface also comprises monofilament fibers.

10. The mat of claim 1, wherein the rubber layer comprises a first surface and a second surface, wherein the textile layer covers at least a portion of the first surface.

11. The mat of claim 10, wherein the textile layer covers the entire first surface.

12. The mat of claim 10, wherein the textile layer covers at least a portion of both the first and second surfaces.

13. The mat of claim 1, wherein the barrier material acts to reduce or prevent migration of breakdown products from the rubber particles.

14. The mat of claim 1, wherein the binder material comprises between approximately 6 and 10 percent of the rubber layer.

15. The mat of claim 1, wherein the rubber layer further comprises a coloring pigment.
